(19) United States
(12) Patent Application Publication
(10) Pub. No.: US 2024/0160575 A1
(43) Pub. Date: May 16, 2024

(54) STORAGE DEVICE FOR LOAD BALANCING AND METHOD THEREFOR

(71) Applicant: Samsung Electronics Co., Ltd., Suwon-si (KR)

(72) Inventor: Junchul CHOI, Suwon-si (KR)

(73) Assignee: Samsung Electronics Co., Ltd., Suwon-si (KR)

(21) Appl. No.: 18/312,349

(22) Filed: May 4, 2023

(30) Foreign Application Priority Data
Nov. 15, 2022 (KR) 10-2022-0152828

(51) Int. Cl. G06F 12/10

(52) U.S. Cl. CPC G06F 12/10

(57) ABSTRACT

Disclosed is a storage device including a nonvolatile memory and a storage controller connected to the nonvolatile memory through a plurality of channels and controlling the nonvolatile memory. The storage controller is configured to receive a command from a host device, check a workload of a mapping channel, to which the command is to be allocated, from among the plurality of channels, and queue the command without allocating the command to the mapping channel in response to the workload of the mapping channel exceeding a threshold workload, increase the workload of the mapping channel in response to the workload of the mapping channel not being greater than the threshold workload, and allocate a descriptor for performing an operation according to the command to the command.

### CROSS-REFERENCE TO RELATED APPLICATIONS

This application claims priority under 35 U.S.C. § 119 to Korean Patent Application No. 10-2022-0152828 filed on Nov. 15, 2022, in the Korean Intellectual Property Office, the disclosures of which is incorporated by reference herein in its entirety.

### BACKGROUND

Example embodiments of the present disclosure described herein relate to a storage device for load balancing, and an operating method therefor.

A storage device may have a limited number of commands capable of being processed and supported inside a device due to resource limitations. In this case, in a case of randomly accessing a memory included in the storage device and processing an operation according to a command, an imbalance of commands allocated to certain channels connected to the memory may occur. For example, a channel to which a small number of commands are allocated may momentarily have an idle period, and a channel to which a large number of commands are allocated may exceed a threshold workload. Accordingly, the availability of the entire channel may have a problem.

### SUMMARY

Example embodiments of the present disclosure provide a storage device that is capable of optimizing or improving channel availability by managing workloads in units of channel connected to a memory and performing load balancing, and an operating method therefor.

According to an example embodiment, a storage device includes a nonvolatile memory and a storage controller connected to the nonvolatile memory through a plurality of channels and controlling the nonvolatile memory. The storage controller is configured to receive a command from a host device, check a workload of a mapping channel, to which the command is to be allocated, from among the plurality of channels, queue the command in a pending queue without allocating the command to the mapping channel in response to the workload of the mapping channel exceeding a threshold workload, increase the workload of the mapping channel in response to the workload of the mapping channel not being greater than the threshold workload, and allocate a descriptor for performing an operation according to the command to the command.

According to another example embodiment, an operating method performed by a storage device includes receiving a command from a host device, checking a workload of a mapping channel, to which the command is to be allocated, from among a plurality of channels, and queuing the command in a pending queue without allocating the command to the mapping channel in response to the workload of the mapping channel exceeding a threshold workload.

According to another example embodiment, a storage controller connected to a nonvolatile memory through a plurality of channels and configured to control the nonvolatile memory. The storage controller is configured to check a mapping channel, to which a command received from a host device is to be allocated, from among the plurality of channels, check a workload of the mapping channel, queue the command in a pending queue without allocating the command to the mapping channel when the workload of the mapping channel exceeds a threshold workload, in response to the workload of the mapping channel not being greater than the threshold workload, increase the workload of the mapping channel, and allocate a descriptor for performing an operation according to the command to the command.

### BRIEF DESCRIPTION OF THE FIGURES

The above and other objects and features of the present disclosure will become apparent by describing in detail example embodiments thereof with reference to the accompanying drawings.

FIG. 1 illustrates a storage device, according to an example embodiment of the present disclosure.

FIG. 2 illustrates a storage device, according to another example embodiment of the present disclosure.

FIG. 3 illustrates a storage controller, according to an example embodiment of the present disclosure.

FIG. 4 is a diagram for describing an operation of a storage controller, according to an example embodiment of the present disclosure.

FIG. 5 is a diagram for describing an operation of a storage system, according to an example embodiment of the present disclosure.

FIG. 6 is for describing a load balancing operation, according to an example embodiment of the present disclosure.

FIG. 7 is for describing a processing operation of a command stored in a pending queue, according to an example embodiment of the present disclosure.

FIG. 8 is for describing an operation after a read command of a storage system is terminated, according to an example embodiment of the present disclosure.

FIG. 9 is a diagram of a descriptor pool according to an example embodiment of the present disclosure.

FIG. 10 illustrates allocation of a DMA descriptor and a command processing operation of a storage device, according to an example embodiment of the present disclosure.

FIG. 11 is a flowchart of an operating method of a storage device, according to an example embodiment of the present disclosure.

FIG. 12 is a flowchart of an operating method of a storage device, according to another example embodiment of the present disclosure.

FIG. 13 is a flowchart of an operating method of a storage device, according to another example embodiment of the present disclosure.

FIG. 14 is a flowchart of an operating method of a storage device after a read operation, according to an example embodiment of the present disclosure.

FIG. 15 illustrates a storage device, according to another example embodiment of the present disclosure.

FIG. 16 illustrates a storage system, according to an example embodiment of the present disclosure.

### DETAILED DESCRIPTION

Hereinafter, example embodiments of the present disclosure may be described in detail and clearly to such an extent that an ordinary one in the art easily implements the example embodiments.

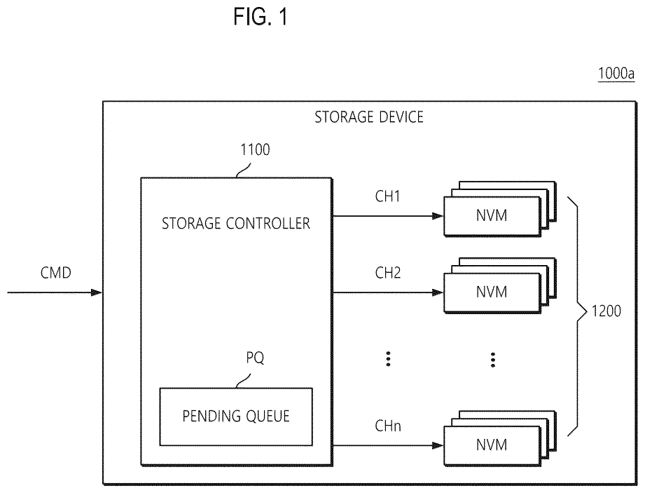

FIG. 1 illustrates a storage device, according to an example embodiment of the present disclosure.

Referring to FIG. 1, a storage device 1000a according to an example embodiment includes a storage controller 1100 and a nonvolatile memory 1200.

The storage device 1000a may receive a command CMD from a host device 10 and may perform an operation according to the command CMD through the nonvolatile memory 1200. For example, the command CMD may include a write command indicating a write operation and a read command indicating a read operation.

Each command CMD may include logical address information about the nonvolatile memory 1200 in which an operation according to the command CMD is performed. When the plurality of commands CMD are transmitted from the host device 10, logical addresses of the command CMD may be sequential or random. Hereinafter, for convenience of description, it is assumed that the command CMD is transmitted while having a random logical address. Here, the meaning that a logical address is random means that a series (e.g., two or more) of logical addresses does not have continuity. For example, a logical block address (LBA), which is a logical address managed by the host device, or a logical page number (LPN), which is a logical address managed by the storage device 1000a, may be randomly processed.

In an example embodiment, the storage device 1000a may be SSD, UFS, or eMMC. Alternatively, in an example embodiment, the storage device 1000a may be implemented with a secure digital (SD) card, a micro SD card, a memory stick, a chip card, a universal serial bus (USB) card, a smart card, a compact flash (CF) card, or a form similar thereto, and is not limited to the above-described example embodiments.

In an example embodiment, the storage device 1000a may be implemented with 3.5 inches, 2.5 inches, 1.8 inches, M.2, U.2, U.3, enterprise and data Center SSD form factor (EDSFF), new form factor 1 (NF1), and/or a form factor similar thereto.

In an example embodiment, the storage device 1000a may be implemented with small computer system interface (SATA), small computer system interface (SCSI), serial attached SCSI (SAS), and/or an interface similar thereto, and may be implemented with peripheral component interconnect (PCI), PCI express (PCIe), nonvolatile memory express (NVMe), NVMe-over-Fabrics (NVMe-oF), Ethernet, InfiniBand, fiber channel, and/or a protocol similar thereto.

The storage controller 1100 controls overall operations of the storage device 1000a.

The storage controller 1100 may control the nonvolatile memory 1200 connected to the storage controller 1100 through a plurality of channels CH1 to CHn depending on the command CMD received from the host device. For example, the storage controller 1100 may perform a write operation, a read operation, or an erase operation on the nonvolatile memory 1200 by providing an address, the command CMD, and a control signal to the nonvolatile memory 1200.

In an example embodiment, when the plurality of commands CMD are received, the storage controller 1100 performs an operation according to the command CMD through a channel, which corresponds to a logical address where each command CMD is to be processed, and the nonvolatile memory 1200 connected to the channel. First of all, the storage controller 1100 checks a channel (hereinafter referred to as a “mapping channel”), to which the command CMD is to be allocated, from among the plurality of channels CH1 to CHn, and allocates the command CMD to the corresponding mapping channel. As described above, when each command CMD has a random logical address, the storage controller 1100 may not sequentially allocate the command CMD from one channel, but may allocate the command CMD to a random channel depending on a random logical address of each command CMD. However, in each channel, the command CMD may be processed in the order in which the command CMD is allocated.

In an example embodiment, when the storage controller 1100 processes any command CMD, the storage controller 1100 may process the command CMD depending on the workload of a mapping channel, to which the command CMD is to be allocated, from among the plurality of channels CH1 to CHn. In particular, the storage controller 1100 may manage a mapping channel or a workload of the entire plurality of channels CH1 to CHn including the mapping channel. While managing the workload, the storage controller 1100 may monitor whether the workload of each channel exceeds a preset (or alternatively, threshold) workload TH. Here, for example, the preset (or alternatively, threshold) workload TH may be set in consideration of the throughput of the command CMD for each channel for achieving the maximum or improved performance when the storage controller 1100 processes the command CMD through each channel.

When the workload of the mapping channel, to which the command CMD is to be allocated, is not greater than the preset (or alternatively, threshold) workload TH, the storage controller 1100 allocates the command CMD to a mapping channel. However, when the workload of the mapping channel to which the command CMD is to be allocated exceeds the preset (or alternatively, threshold) workload TH, the storage controller 1100 may queue the command CMD in a pending queue PQ managed by the storage device 1000a without allocating the command CMD to a mapping channel. That is, when it is determined that the storage controller 1100 is not capable of achieving maximum or improved performance because the workload of the mapping channel to be allocated is already excessive, the storage controller 1100 may suspend allocating the command CMD to the mapping channel and may queue the command CMD in the pending queue PQ instead.

The pending queue PQ may be a storage space (or data structure) where the command CMD for which channel allocation is pending is temporarily stored. In an example embodiment, the pending queue PQ may be internally managed by the storage controller 1100 as shown in FIG. 1, but is not limited thereto.

The pending queue PQ may be provided for each of (or alternatively, at least one of) the plurality of channels CH1 to CHn. In detail, as described above, because an operation according to the command CMD is performed on an arbitrary logical address when the command CMD has a random logical address, the command CMD may fail to be evenly allocated to the plurality of channels CH1 to CHn, and thus deviation may occur. That is, each of (or alternatively, at least one of) the plurality of channels CH1 to CHn may be in a state where a workload is excessive. Accordingly, the storage controller 1100 may manage the pending queue PQ for each of (or alternatively, at least one of) the plurality of channels CH1 to CHn.

According to the above-described example embodiment, the storage controller 1100 may perform load balancing in consideration of a workload of each channel. Accordingly, even when the command CMD is randomly allocated, deviation of throughput of the command CMD for each channel may be reduced.

In an example embodiment, the storage controller 1100 may continuously monitor a workload of the mapping channel after queuing the command CMD in the pending queue PQ. Afterward, when the workload of the mapping channel is resolved (e.g., when the workload is not greater than the preset workload TH), the storage controller 1100 may queue the command CMD stored in the pending queue PQ and may allocate the command CMD to the mapping channel.

The nonvolatile memory 1200 is controlled by the storage controller 1100. The nonvolatile memory 1200 may store data transmitted from the host device 10, data generated by the storage device 1000a, or other various data written by the storage controller 1100. In an example embodiment, the nonvolatile memory 1200 may be the arbitrary nonvolatile memory 1200 such as a NAND flash memory, a phase change random access memory (PRAM), a resistance random access memory (RRAM), a nano floating gate memory (NFGM), a polymer random access memory (PoRAM), a magnetic random access memory (MRAM), or a ferroelectric random access memory (FRAM), but is not limited thereto.

In an example embodiment, as shown, the nonvolatile memory 1200 may include a plurality of memory chips. The nonvolatile memory 1200 may include one or more memory chips to correspond to each of (or alternatively, at least one of) the plurality of channels CH1 to CHn. The storage controller 1100 may exchange data according to the command CMD of each of (or alternatively, at least one of) the plurality of channels CH1 to CHn with the nonvolatile memory 1200 through the plurality of channels CH1 to CHn. Each memory chip may have a physical address corresponding to a logical address. The storage controller 1100 may perform an operation according to the command CMD on a memory chip corresponding to a specific physical address. That is, the physical address means a real location where data is to be accessed.

When the command CMD is a read command, the nonvolatile memory 1200 may deliver data, which is stored in the nonvolatile memory 1200 or one or more memory chips included in the nonvolatile memory 1200, to the storage controller 1100 under the control of the storage controller 1100. The storage controller 1100 may transmit data read from the nonvolatile memory 1200 to the host device.

According to the above-described example embodiments of the present disclosure, the storage device 1000a may perform load balancing according to a workload in units of channel connected to the nonvolatile memory 1200. In detail, the storage device 1000a may allocate the command CMD in consideration of a workload for each channel. When the workload of a channel to be allocated is excessive, the storage device 1000a may queue the command CMD in the pending queue PQ managed by the storage device 1000a without allocating the command CMD. When performing an operation according to the command CMD on random logical addresses, the command CMD allocated to the channel may be unbalanced when there is no load balancing for each channel. However, according to an example embodiment of the present disclosure, such the imbalance for each channel may be resolved, and thus the availability of the channel may be optimized or improved.

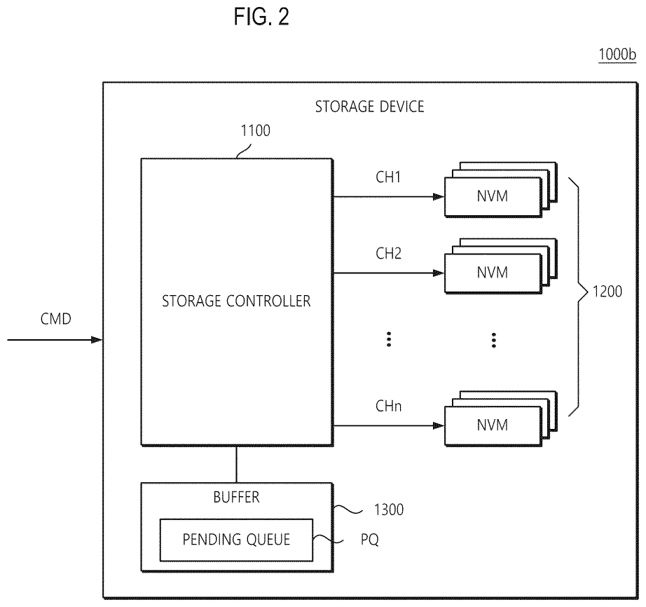

FIG. 2 illustrates a storage device, according to another example embodiment of the present disclosure.

Referring to FIG. 2, a storage device 1000b according to another example embodiment may include a buffer 1300 in addition to the storage controller 1100 and the nonvolatile memory 1200 shown in FIG. 1.

The buffer 1300 may be connected to the storage controller 1100 to temporarily store write data received from the host device 10 or read data read from the nonvolatile memory 1200. The buffer 1300 may be implemented with a volatile memory such as a dynamic random-access memory (DRAM) or a static RAM (SRAM).

In an example embodiment, the buffer 1300 may store the pending queue PQ for queuing the command CMD described above. When the workload of the mapping channel to be allocated is excessive before the command CMD is allocated, the storage controller 1100 may suspend channel allocation of the command CMD and may store the command CMD, for which channel allocation is suspended, in the pending queue PQ stored in the buffer 1300. Afterward, when the workload of the mapping channel is resolved (e.g., when the workload falls not to be greater than the preset (or alternatively, threshold) workload TH), the storage controller 1100 may queue the command CMD stored in the pending queue PQ of the buffer 1300 and may allocate the command CMD to the mapping channel.

The pending queue PQ according to an example embodiment may be stored and managed in the buffer 1300 connected to the outside of the storage controller 1100 as shown in FIG. 2. However, as shown in FIG. 1, the storage controller 1100 may internally store and manage the pending queue PQ. In this case, the buffer 1300 may be provided inside the storage controller 1100.

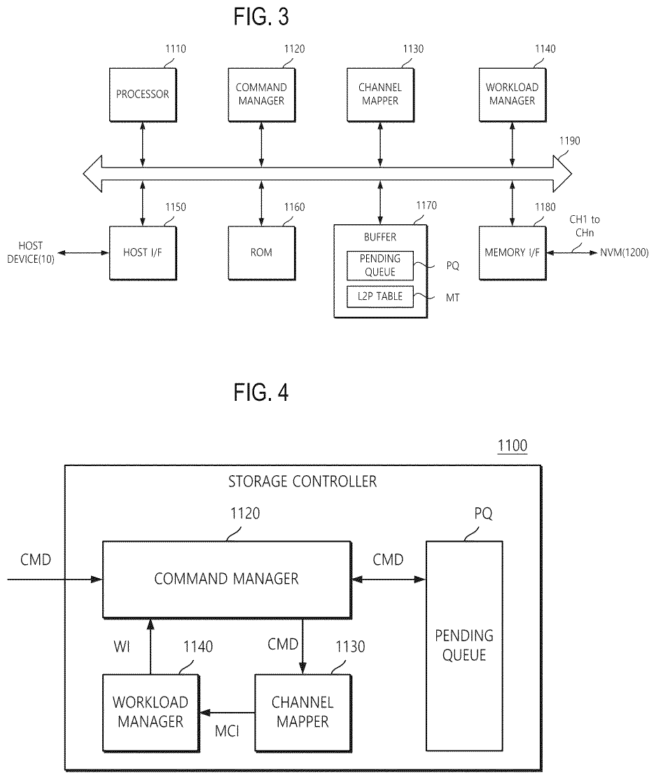

FIG. 3 illustrates a storage controller, according to an example embodiment of the present disclosure.

Referring to FIG. 3, the storage controller 1100 according to an example embodiment includes a processor 1110, a command manager 1120, a workload manager 1140, a channel mapper 1130, a host interface 1150, a ROM 1160, a buffer 1170, and a memory interface 1180. Each of (or alternatively, at least one of) the components may be electrically connected to each other through a bus 1190 to exchange data.

The processor 1110 may be a data processing device capable of processing data, such as a central processing unit (CPU), a processor, a microprocessor, or an application processor (AP). The processor 1110 may control overall operations of the storage devices 1000a and 1000b.

The command manager 1120 may process and manage the command CMD delivered from the host device 10 through the host interface 1150. In an example embodiment, the command manager 1120 may fetch the command CMD from the host device 10.

In an example embodiment, the command manager 1120 may allocate the fetched command CMD to a channel. In an example embodiment, when the workload of a mapping channel exceeds the preset (or alternatively, threshold) workload TH, the command manager 1120 may queue the command CMD without allocating the command CMD to a mapping channel. For example, the command manager 1120 may queue the command CMD, whose allocation is pending, in the pending queue PQ stored in the buffer 1170. Alternatively, according to an example embodiment, when the pending queue PQ is stored in the buffer 1300 provided outside the storage controller 1100 as illustrated in FIG. 2, the command CMD may be queued in the corresponding buffer 1300.

In an example embodiment, the command manager 1120 may process the command CMD received from the host device 10 based on direct memory access (DMA) transmission. The command manager 1120 may allocate a DMA descriptor having a specific DMA processing size for the received command CMD. Each DMA descriptor may be defined as a data structure that records information related to the command CMD, such as the type of the command CMD, the size of processing data, and source and destination addresses. When the DMA descriptor is allocated to the command CMD, the command manager 1120 may transmit the corresponding DMA descriptor to the mapping channel. The nonvolatile memory 1200 may perform an operation according to the command CMD with reference to a DMA descriptor.

The channel mapper 1130 checks a mapping channel, to which the command CMD received from the host is to be allocated, from among the plurality of channels CH1 to CHn connected to the nonvolatile memory 1200. For example, the channel mapper 1130 may perform an address mapping operation of mapping an LBA, which is a logical address of the command CMD, to a physical block address (PBA) of the nonvolatile memory 1200 by using a flash translation layer (FTL). The channel mapper 1130 may perform the address mapping operation based on a L2P table MT stored in the buffer 1170. The channel mapper 1130 may check a physical address corresponding to a logical address through address mapping and may check a mapping channel corresponding to the corresponding physical address.

The workload manager 1140 checks and manages workloads of the plurality of channels CH1 to CHn including a mapping channel. Each of the channels CH1 to CHn having a corresponding workload WL1 to WLn. In an example embodiment, the workload manager 1140 may map and manage workload information about a workload for each channel. In some example embodiments, the workload may be defined in various ways. The workload may be defined as the number of commands pre-allocated to each channel. In this case, the workload information may indicate the number of pre-allocated commands to each channel. Alternatively, the workload may be defined as the number of DMA descriptors pre-allocated to each channel. In this case, the workload information may indicate the number of DMA descriptors pre-allocated to each channel.

The host interface 1150 is an interface connected to the host device 10 to perform a host interface layer (HIL)-related operation. For example, the storage controller 1100 may process the command CMD (or a request) input from the host device 10 through the host interface 1150.

The ROM 1160 may store codes and data necessary for driving the storage controller 1100. The buffer 1170 may buffer and store write data transmitted from the host device 10 or read data transmitted from the nonvolatile memory 1200. In addition, the codes and data necessary for driving the storage controller 1100 may be loaded from the ROM 1160 to the buffer 1170 during initialization or booting of the storage devices 1000a and 1000b. In an example embodiment, the buffer 1170 may store the pending queue PQ or the L2P table MT for queuing the command CMD for which channel allocation is pending.

The memory interface 1180 is an interface connected to the nonvolatile memory 1200 to perform a flash interface layer (FIL)-related operation. For example, the storage controller 1100 may transmit/receive data to be written to or read data from the nonvolatile memory 1200 through the memory interface 1180.

Hereinafter, a load balancing operation of the storage devices 1000a and 1000b and the storage controller 1100 according to the above-described example embodiments will be described in detail.

FIG. 4 is a diagram for describing an operation of a storage controller, according to an example embodiment of the present disclosure.

Referring to FIG. 4, as described above, the storage controller 1100 according to an example embodiment includes the command manager 1120, the channel mapper 1130, and the workload manager 1140. In addition, for convenience of description, the pending queue PQ is shown to be managed inside the storage controller 1100, but is not limited thereto as described above.

First of all, the command manager 1120 fetches the command CMD from the host device 10 and delivers the fetched command CMD to the channel mapper 1130.

The channel mapper 1130 checks a physical address corresponding to a logical address of the command CMD based on the L2P table MT. Because the physical address indicates the physical location of the nonvolatile memory 1200 where an operation according to the command CMD is to be processed, the channel mapper 1130 may check the nonvolatile memory 1200 and a channel connected to the nonvolatile memory 1200 through the physical address. When the channel mapper 1130 checks a channel, to which the command CMD is to be allocated, that is, a mapping channel, the channel mapper 1130 delivers mapping channel information MCI to the workload manager 1140.

The workload manager 1140 manages workloads of the plurality of channels CH1 to CHn. When the workload manager 1140 receives the mapping channel information MCI, the workload manager 1140 delivers workload information WI indicating the workload of the mapping channel indicated by the mapping channel information MCI to the command manager 1120.

The command manager 1120 determines whether the workload of the mapping channel is excessive, based on the workload information WI. In an example embodiment, when the workload exceeds the preset (or alternatively, threshold) workload TH, the command manager 1120 queues the command CMD in the pending queue PQ without allocating the command CMD to the mapping channel Alternatively, when the workload is not greater than the preset (or alternatively, threshold) workload TH, the command manager 1120 may normally allocate the command CMD to the mapping channel.

When the command CMD is allocated to the mapping channel, the workload manager 1140 may increase the workload of the corresponding mapping channel.

According to the above-described example embodiments of the present disclosure, when processing a command, the storage controller 1100 may check a channel, to which a command is allocated, through the channel mapper 1130, may check the workload of the corresponding channel through the workload manager 1140, and may perform load balancing in consideration of a workload through the command manager 1120. Accordingly, the storage device 1000a may prevent or reduce the imbalance of workloads between channels and may optimize or improve channel availability even when commands for random logical addresses are processed.

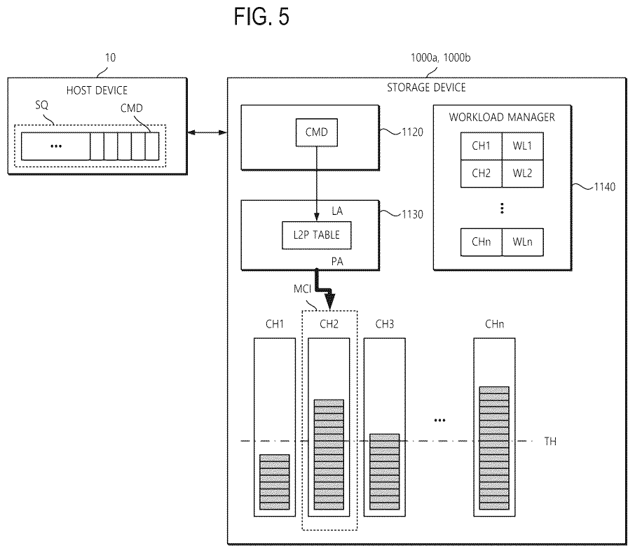

FIG. 5 is a diagram for describing an operation of a storage system, according to an example embodiment of the present disclosure.

Referring to FIG. 5, a storage system according to an example embodiment includes the host device 10 and the storage devices 1000a and 1000b connected to the host device 10.

The host device 10 may store the command CMD in a submission queue SQ. When the plurality of commands CMD are generated, the plurality of commands CMD may be randomly stored in the submission queue SQ regardless of the order of logical addresses.

The command manager 1120 included in the storage devices 1000a and 1000b may fetch the command CMD stored in the submission queue SQ. The fetched command CMD is delivered from the command manager 1120 to the channel mapper 1130. As described above, the channel mapper 1130 checks the physical address of the command CMD based on the L2P table MT and checks the mapping channel corresponding to the physical address. Hereinafter, for convenience of description, a mapping channel among the illustrated plurality of channels CH1 to CHn will be described as the second channel CH2.

The workload manager 1140 manages a workload for each of (or alternatively, at least one of) the plurality of channels CH1 to CHn. The workload manager 1140 may usually manage the workload for each channel and may manage the workload information WI mapped for each channel, as shown in FIG. 5.

As shown in FIG. 5, a command (or DMA descriptor) pre-allocated by the storage controller 1100 is already present in each of (or alternatively, at least one of) the plurality of channels CH1 to CHn. When a workload is defined as the number of commands pre-allocated to a mapping channel, the preset (or alternatively, threshold) workload TH may be defined as the number of commands CMD allocated to a channel for achieving the maximum or improved performance. Then, in the case of FIG. 5, a workload of each of (or alternatively, at least one of) the second channel CH2, the third channel CH3, and the n-th channel CHn among the plurality of channels CH1 to CHn already exceeds the preset (or alternatively, threshold) workload TH. In particular, it may be identified by the channel mapper 1130 that the second channel CH2 is a mapping channel, but it may be identified that a workload is excessive.

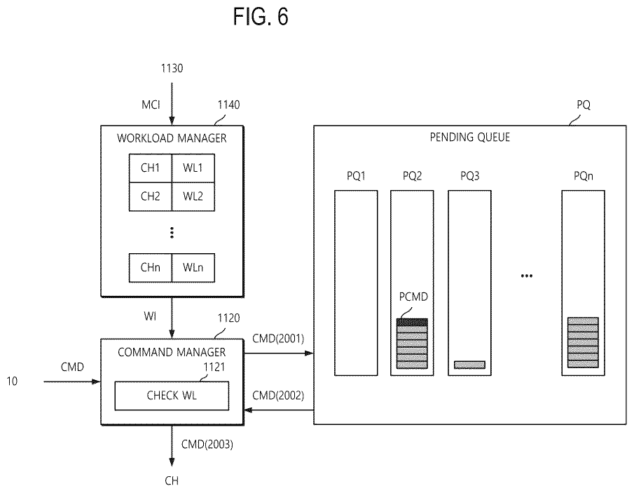

FIG. 6 is for describing a load balancing operation, according to an example embodiment of the present disclosure.

Referring to FIG. 6, the workload manager 1140 may receive the mapping channel information MCI from the channel mapper 1130. The workload manager 1140 delivers the workload information WI corresponding to the mapping channel information MCI among the managed workloads to the command manager 1120.

The command manager 1120 checks whether the workload of the mapping channel included in the workload information WI exceeds the preset (or alternatively, threshold) workload TH (1121). When the workload of the mapping channel exceeds the preset (or alternatively, threshold) workload TH, the command manager 1120 suspends the allocation of the command CMD fetched from the host, and queues the allocated command PCMD in the pending queue PQ (2001). The pending queue PQ may be provided for each of (or alternatively, at least one of) the plurality of channels CH1 to CHn a corresponding pending queue PQ1 to PQn. For example, when the mapping channel is the second channel CH2, the command manager 1120 may queue the command CMD in the second the pending queue PQ allocated to the second channel CH2.

Afterward, when the workload of the mapping channel decreases and then eventually is not greater than the preset (or alternatively, threshold) workload TH, the command manager 1120 may queue the command CMD stored in the pending queue PQ from the pending queue PQ (2002).

When the workload of the mapping channel is not greater than the preset (or alternatively, threshold) workload TH, the command manager 1120 normally allocates the fetched command CMD to a channel (2003).

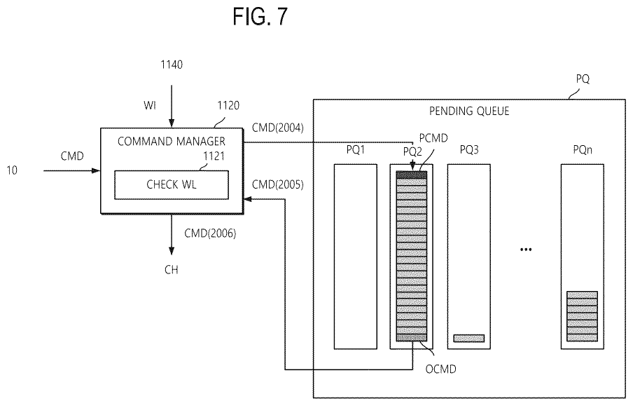

FIG. 7 is for describing a processing operation of a command stored in a pending queue, according to an example embodiment of the present disclosure.

Referring to FIG. 7, the command manager 1120 may check the workload of a mapping channel depending on the workload information WI received from the workload manager 1140 (1121). In the case, when the workload of the mapping channel exceeds the preset (or alternatively, threshold) workload TH, as described above, the command CMD may be queued in the pending queue PQ corresponding to the corresponding mapping channel.

However, when there is no space to queue the command CMD because the pending queue PQ is full, the command manager 1120 queues a pending command PCMD by pushing the pending command PCMD into the pending queue PQ (2004). Moreover, the command manager 1120 queues the head of the corresponding pending queue PQ, that is, the oldest command OCMD (2005). Afterward, the command manager 1120 allocates the oldest command OCMD thus queued to a channel (2006).

In this case, an operation of allocating the oldest command OCMD to the channel has been performed together with queuing the pending command PCMD, and thus the workload manager 1140 may increase the workload of the managed mapping channel.

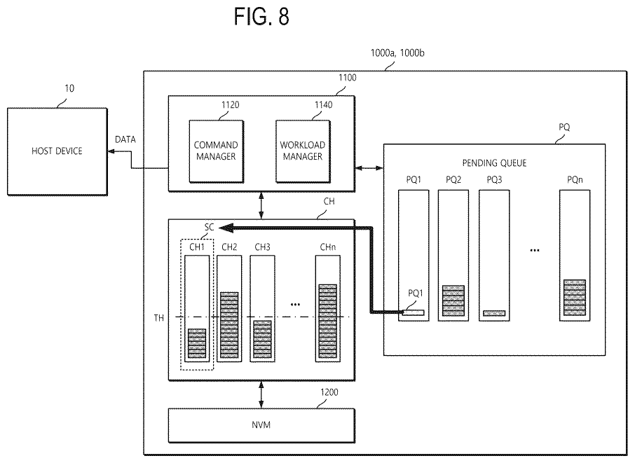

FIG. 8 is for describing an operation after a read command of a storage system is terminated, according to an example embodiment of the present disclosure.

Referring to FIG. 8, when the command CMD is a read command, the storage devices 1000a and 1000b may read out data from the nonvolatile memory 1200 and transmit the read data DATA to the host device 10.

After the read data DATA is transmitted to the host device 10 through the storage controller 1100, the storage devices 1000a and 1000b may continuously perform load balancing.

First of all, the command manager 1120 included in the storage controller 1100 determines whether the pending queue PQ is empty. When another command is stored in the pending queue PQ, the command manager 1120 determines, through the workload manager 1140, whether a channel, which has a workload not greater than the preset (or alternatively, threshold) workload TH, from among the plurality of channels CH1 to CHn is present.

When it is determined that at least one channel CH1 or CH4, whose workload is not greater than the preset (or alternatively, threshold) workload TH, from among the plurality of channels CH1 to CHn is present, the command manager 1120 selects one channel SC having the minimum or a lowest workload among at least one channel CH1 or CH4. For example, in the illustrated channel, the workload of each of (or alternatively, at least one of) the first channel CH1 and the third channel CH3 is not greater than the preset (or alternatively, threshold) workload TH. Among the first channel CH1 and the third channel CH3, the workload of the first channel CH1 is lowest, and thus the command manager 1120 selects the first channel CH1.

The command manager 1120 queues another command stored in the pending queue PQ from the pending queue PQ and allocates the other command to the selected channel SC.

According to the above example embodiments, the storage devices 1000a and 1000b may read out data to transmit the data to the host device 10 depending on a read command, and may select a channel with the best workload. The channel availability is improved through load balancing that processes the command CMD stored in the pending queue PQ related to the corresponding channel.

As described above, the storage devices 1000a and 1000b according to an example embodiment may process the command CMD based on DMA transmission. To this end, the storage devices 1000a and 1000b according to an example embodiment may allocate a DMA descriptor to the command CMD. The allocated DMA descriptor may be stored in a DMA descriptor pool managed by the storage devices 1000a and 1000b. The storage devices 1000a and 1000b may check the workload before allocating the command CMD to the mapping channel, and may allocate a DMA descriptor to allocate the command CMD to the mapping channel only when the workload is appropriate.

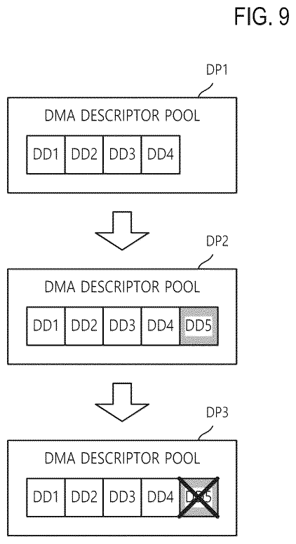

FIG. 9 is a diagram of a descriptor pool according to an example embodiment of the present disclosure.

Referring to FIG. 9, descriptor pools according to an example embodiment may store at least one DMA descriptor allocated to the command CMD. Each DMA descriptor may be allocated for each command CMD and may be stored in a descriptor pool. The descriptor pool has limited storage space.

A first descriptor pool DP1 indicates that no DMA descriptor is allocated to the command CMD that the storage devices 1000a and 1000b currently desires to process.

Afterward, when the command CMD for a specific mapping channel is checked, the storage devices 1000a and 1000b may check the workload of the mapping channel to which the command CMD is allocated. When the workload of the mapping channel exceeds the preset (or alternatively, threshold) workload TH, a new DMA descriptor is not still allocated. When the workload of the mapping channel is not greater than the preset (or alternatively, threshold) workload TH, the storage devices 1000a and 1000b may allocate a new DMA descriptor DD5 to the command CMD. A second descriptor pool DP2 indicates that the new DMA descriptor DD5 is allocated. The storage devices 1000a and 1000b may transmit the allocated new DMA descriptor DD5 through the mapping channel. The nonvolatile memory 1200 connected to the mapping channel may perform an operation according to the command CMD with reference to the new DMA descriptor DD5.

Afterward, when the operation according to the command CMD is normally completed, the storage devices 1000a and 1000b may release the allocated DMA descriptor DD5. The third descriptor pool DP3 indicates that allocation of the allocated DMA descriptor is released.

According to the above-described embodiment, when the workload of the mapping channel is excessive, the storage devices 1000a and 1000b may not allocate a DMA descriptor, and may allocate a DMA descriptor only when the workload is free. Accordingly, according to an example embodiment of the present disclosure, resources of a DMA descriptor pool having a limited storage space may be appropriately utilized by allocating a DMA descriptor in consideration of the workload of a channel.

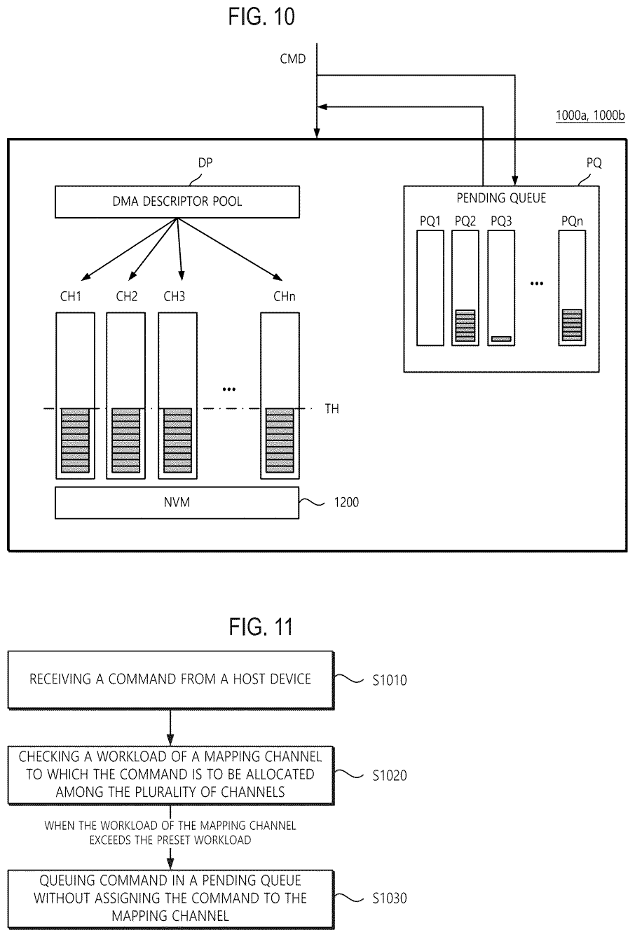

FIG. 10 illustrates allocation of a DMA descriptor and a command processing operation of a storage device, according to an example embodiment of the present disclosure.

Referring to FIG. 10, the storage devices 1000a and 1000b according to an example embodiment may fetch the command CMD from a host device. The storage devices 1000a and 1000b may allocate a DMA descriptor included in a DMA descriptor pool DP to each command CMD. The allocated DMA descriptor may be transmitted to the nonvolatile memory 1200 through the plurality of channels CH1 to CHn. The nonvolatile memory 1200 may perform an operation according to the command CMD with reference to a DMA descriptor. When the operation of the nonvolatile memory 1200 is terminated, the storage devices 1000a and 1000b may return the allocated DMA descriptor and may fetch the new command CMD.

At this time, because the DMA descriptor allocated to the command CMD is sequentially returned when the operation in the nonvolatile memory 1200 is completed, the one or more commands CMD having a completed operation may be present such that the storage devices 1000a and 1000b achieves maximum or improved performance. Because the allocation and transmission of a DMA descriptor is continuously performed, channel availability may be maximized or improved. Accordingly, it is necessary to accumulate the command CMDs having a specific level or higher (e.g., the preset workload TH described above) in the plurality of channels CH1 to CHn.

According to the above-described example embodiments, when the workload of a specific channel exceeds the preset (or alternatively, threshold) workload TH, the storage controller 1100 may queue the command CMD in the pending queue PQ without allocating the command CMD to a mapping channel, or may process the command CMD, which is allocated to a channel with a good workload status and which is stored in the pending queue PQ.

The storage controller 1100 may allocate the command CMD of a specific level or higher to a channel as evenly as possible. Accordingly, because there is at least one command CMD of which an operation is completed, a DMA descriptor may be seamlessly allocated, and thus, channel availability may be optimized or improved.

In particular, the command CMD may be allocated for each of (or alternatively, at least one of) the plurality of channels CH1 to CHn such that a condition that the workload for each of (or alternatively, at least one of) the plurality of channels CH1 to CHn is not less than the preset (or alternatively, threshold) workload TH is satisfied. Restated, the storage controller 110 allocates the commands to the channels CH1 to CHn based on maintaining a condition that a workload for each of the plurality of channels is not less than the threshold workload. In this case, at least one or more commands CMD having the completed operation may be always present, and thus at least one descriptor of which the allocation is released may be always present.

Hereinafter, an operating method of the storage devices 1000a and 1000b according to the above-described example embodiments will be described.

FIG. 11 is a flowchart of an operating method of a storage device, according to an example embodiment of the present disclosure.

Referring to FIG. 11, in an example embodiment, the storage devices 1000a and 1000b may receive the command CMD from the host device 10 (S1010). For example, the storage devices 1000a and 1000b may fetch the command CMD stored in the submission queue SQ of the host device 10.

The storage devices 1000a and 1000b may check the workload of a mapping channel to which the received command CMD is to be allocated among the plurality of channels CH1 to CHn (S1020).

When it is determined in operation S1020 that the workload of the mapping channel to which the command CMD is to be allocated exceeds the preset (or alternatively, threshold) workload TH, the storage devices 1000a and 1000b may queue the command CMD in the pending queue PQ without assigning the command CMD to the mapping channel (S1030). For example, the pending queue PQ may be provided for each of (or alternatively, at least one of) the plurality of channels CH1 to CHn, and the storage devices 1000a and 1000b may queue the command CMD in the pending queue PQ corresponding to the mapping channel. If it is determined that the workload of the mapping channel to which the command CMD is to be allocated does not exceed the preset (or alternatively, threshold) workload TH, the storage devices 1000a and 1000b may queue the command CMD in the pending queue PQ and assign the command CMD to the mapping channel.

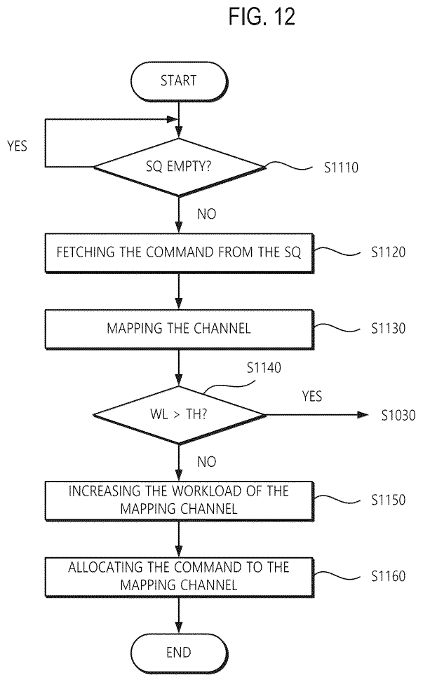

FIG. 12 is a flowchart of an operating method of a storage device, according to another example embodiment of the present disclosure.

Referring to FIG. 12, in an example embodiment, the storage devices 1000a and 1000b may determine whether the submission queue SQ is empty (S1110). In addition, when the submission queue SQ is not empty, the storage devices 1000a and 1000b may also determine whether there is no allocated DMA descriptor.

When the submission queue SQ is not empty (or when the submission queue SQ is not empty and an allocated descriptor is present), the storage devices 1000a and 1000b may fetch the command CMD from the submission queue SQ (S1120). This may correspond to operation S1010 described above.

The storage devices 1000a and 1000b may check (e.g., map) the channel of the command CMD thus fetched (S1130). For example, the storage devices 1000a and 1000b may check the physical address of the command CMD based on the L2P table MT and may check a channel corresponding to the physical address as a mapping channel.

The storage devices 1000a and 1000b may check the workload of the mapping channel (S1140). In particular, the storage devices 1000a and 1000b may determine whether the workload of the mapping channel exceeds the preset (or alternatively, threshold) workload TH.

When the workload exceeds the preset (or alternatively, threshold) workload TH, the storage devices 1000a and 1000b may perform the above-described operation S1030.

When the workload is not greater than the preset (or alternatively, threshold) workload TH, the storage devices 1000a and 1000b may increase the workload of the mapping channel (S1150).

The storage devices 1000a and 1000b may normally allocate the command CMD to the mapping channel (S1160). In an example embodiment, the storage devices 1000a and 1000b may allocate a DMA descriptor to the command CMD and may transmit the allocated DMA descriptor to the mapping channel.

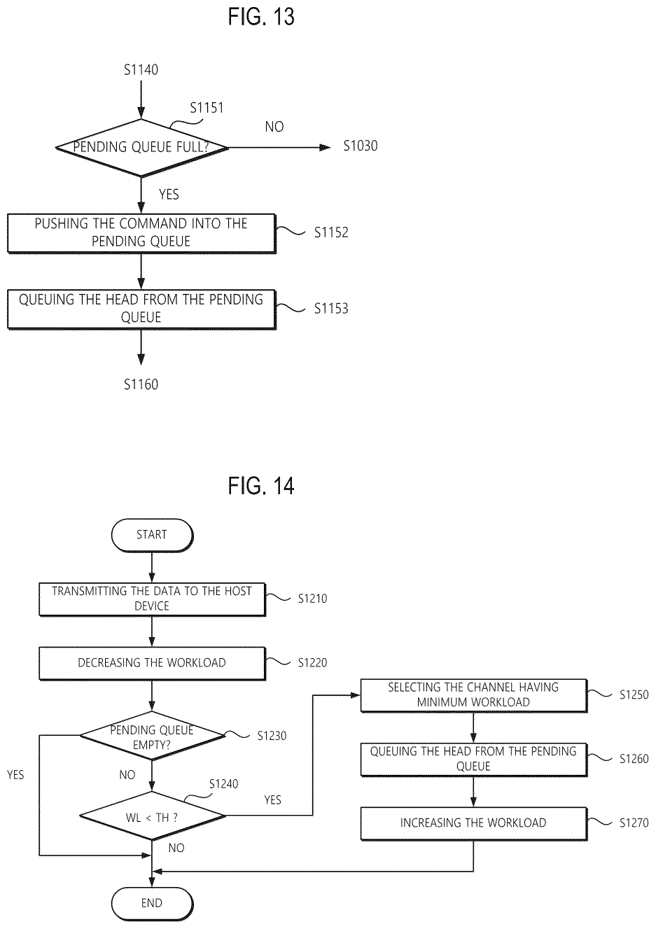

FIG. 13 is a flowchart of an operating method of a storage device, according to another example embodiment of the present disclosure.

Referring to FIG. 13, in an example embodiment, when it is determined in operation S1150 described above that the workload of the mapping channel exceeds the preset (or alternatively, threshold) workload TH, the storage devices 1000a and 1000b may determine whether the pending queue PQ is full (S1151).

When the pending queue PQ is full, the storage devices 1000a and 1000b may push the command CMD into the pending queue PQ (S1152).

Afterward, the storage devices 1000a and 1000b may queue the oldest command OCMD from the pending queue PQ (S1153). Afterward, the storage devices 1000a and 1000b may perform operation S1160 on the queued oldest command OCMD.

When the pending queue PQ is not full, the storage devices 1000a and 1000b may perform operation S1030 of queuing the command CMD in the pending queue PQ.

FIG. 14 is a flowchart of an operating method of a storage device after a read operation, according to an example embodiment of the present disclosure. FIG. 14 has described a read operation, but is not limited thereto.

Referring to FIG. 14, after performing a read operation through the nonvolatile memory 1200, the storage devices 1000a and 1000b may transmit the read data DATA to the host device 10 (S1210). At this time, the storage devices 1000a and 1000b may release the allocated DMA descriptor.

The storage devices 1000a and 1000b may decrease the workload (S1220).

When completing an operation according to the command CMD, that is, a read operation, the storage devices 1000a and 1000b may determine whether the pending queue PQ is empty (S1230).

When another command is stored in the pending queue PQ, the storage devices 1000a and 1000b may determine whether there is a channel whose workload is not greater than the preset (or alternatively, threshold) workload TH among the plurality of channels CH1 to CHn (S1240).

When there is at least one channel whose workload is not greater than the preset (or alternatively, threshold) workload TH among the plurality of channels CH1 to CHn, the storage devices 1000a and 1000b may select one channel having the minimum or a lowest workload among at least one channel (S1250).

The storage devices 1000a and 1000b may queue another command (e.g., a head which is the oldest data in the pending queue PQ) from the pending queue PQ and may allocate the other command to one channel (S1260).

The storage devices 1000a and 1000b may increase the workload (S1270).

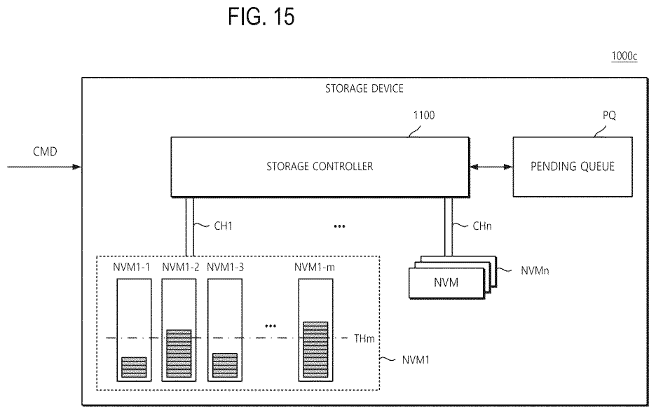

FIG. 15 illustrates a storage device, according to another example embodiment of the present disclosure.

Referring to FIG. 15, a storage device 1000c according to another example embodiment includes the storage controller 1100 and a plurality of nonvolatile memories NVM1 to NVMn connected through the plurality of channels CH1 to CHn. Unlike the above-described example embodiments, the storage controller 1100 according to another example embodiment may perform load balancing in units of the plurality of nonvolatile memories NVM1 to NVMn connected to each channel. Hereinafter, as shown for convenience, the description will be given based on the first channel CH1 and the first nonvolatile memory NVM1 connected to the first channel CH1.

The first nonvolatile memory NVM1 connected to the first channel CH1 includes a plurality of memory chips NVM1-1 to NVM1-m. The command CMD allocated through the first channel CH1 may be allocated to a memory chip corresponding to each physical address among the plurality of memory chips NVM1-1 to NVM1-m. Accordingly, like a channel, workloads are present in the plurality of memory chips NVM1-1 to NVM1-m. For example, a workload may be defined as the number of commands pre-allocated to each memory chip.

The storage controller 1100 may manage a workload of each memory chip and may perform load balancing. In particular, the storage controller 1100 may check whether the workload of one memory chip corresponding to a physical address of the command CMD exceeds a preset (or alternatively, threshold) workload THm.

When the workload of the memory chip to be allocated exceeds the preset (or alternatively, threshold) workload THm, the storage controller 1100 queues the command CMD in the pending queue PQ without allocating the command CMD to a memory chip, like load balancing for each channel. In this case, the pending queue PQ may be provided for each channel or each memory chip.

Accordingly, to the above example embodiments may solve the imbalance of a command processing operation between memory chips by performing load balancing in consideration of a workload in units of memory chips connected to a channel.

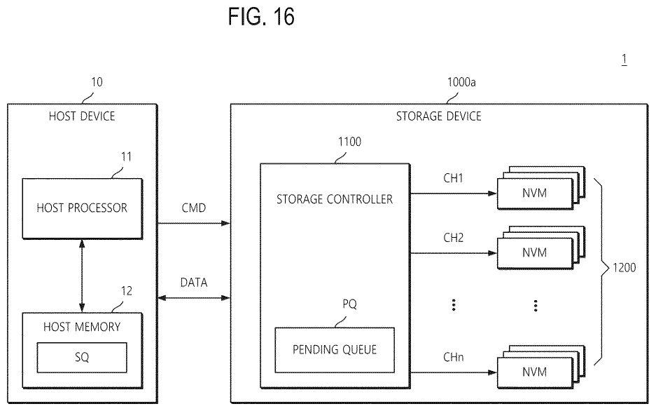

FIG. 16 illustrates a storage system, according to an example embodiment of the present disclosure.

Referring to FIG. 16, a storage system according to an example embodiment includes the host device 10 and the storage device 1000a connected to the host device 10.

The host device 10 includes a host processor 11 and a host memory 12. The host processor 11 may control an operation of the host device 10. For example, the host processor 11 may execute an operating system (OS) for controlling a peripheral device including the storage device 1000a. For example, the host processor 11 may include an arbitrary processor such as a central processing unit (CPU).

The host memory 12 may store instructions and data executed and processed by the host processor 11. For example, the host memory 12 may include a volatile memory (VM) and/or an NVM. In an example embodiment, the host memory 12 may store the submission queue SQ where the command CMD is queued.

The storage device 1000a may be accessed by the host device 10, may receive a request, the command CMD, or other data from the host device 10, or may transmit a response to the request or data stored in the nonvolatile memory 1200.

The storage controller 1100 included in the storage device 1000a may perform load balancing on channels or memory chips according to the above-described example embodiments. For example, the storage controller 1100 may check a workload of a mapping channel to which the command CMD received from the host device 10 is allocated, from among the plurality of channels CH1 to CHn from the host device 10. When the workload of the mapping channel exceeds the preset (or alternatively, threshold) workload TH, the storage controller 1100 may queue the command CMD in the pending queue PQ without allocating the command CMD to a mapping channel.

Although FIG. 16 is shown based on the storage device 1000a, the storage system is not limited thereto. For example, the storage system may include all of the storage devices 1000b and 1000c according to various example embodiments of the present disclosure.

Any of the elements and/or functional blocks disclosed above may include or be implemented in processing circuitry such as hardware including logic circuits; a hardware/software combination such as a processor executing software; or a combination thereof. For example, the storage controller 1100, and command manager 1120, channel mapper 1130, workload manager 1140, storage controller 1100, and host processor 11 may be implemented as processing circuitry. The processing circuitry specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

Processor(s), controller(s), and/or processing circuitry may be configured to perform actions or steps by being specifically programmed to perform those action or steps (such as with an FPGA or ASIC) or may be configured to perform actions or steps by executing instructions received from a memory, or a combination thereof.

The above description refers to detailed example embodiments for carrying out the above-mentioned steps and operations. Example embodiments with simple changes or substitutions in design may also be well understood based on the present disclosure as well as the example embodiment described above. In addition, technologies that are easily changed and implemented by using the above example embodiments may be well understood based on the present disclosure as well as the example embodiment described above. While the present disclosure has been described with reference to example embodiments thereof, it will be apparent to those of ordinary skill in the art that various changes and modifications may be made thereto without departing from the spirit and scope of the present disclosure as set forth in the following claims.

According to an example embodiment of the present disclosure, channel availability may be optimized or improved by managing a workload in units of channel connected to a memory and performing load balancing.

While the present disclosure has been described with reference to example embodiments thereof, it will be apparent to those of ordinary skill in the art that various changes and modifications may be made thereto without departing from the spirit and scope of the present disclosure as set forth in the following claims.

What is claimed is:

1. A storage device comprising:
a nonvolatile memory; and
a storage controller connected to the nonvolatile memory through a plurality of channels and configured to control the nonvolatile memory,
wherein the storage controller is configured to
receive a command from a host device,
check a workload of a mapping channel, to which the command is to be allocated, from among the plurality of channels,
queue the command in a pending queue without allocating the command to the mapping channel in response to the workload of the mapping channel exceeding a threshold workload,
increase the workload of the mapping channel in response to the workload of the mapping channel not being greater than the threshold workload, and
allocate a descriptor for performing an operation according to the command to the command.

2. The storage device of claim 1, wherein,
the workload is defined as a number of commands pre-allocated to the mapping channel,
the storage controller is configured to queue the command in response to the number of the pre-allocated commands exceeding a threshold number.

3. The storage device of claim 1, wherein the pending queue is provided for each of the plurality of channels.

4. The storage device of claim 1, wherein, in response to the workload of the mapping channel not being greater than the threshold workload, the storage controller is configured to queue the command from the pending queue.

5. The storage device of claim 1, wherein
the storage controller is configured to allocate the command based on maintaining a condition that a workload for each of the plurality of channels is not less than the threshold workload, and
wherein the descriptor includes at least one sub-descriptor, the at least one sub-descriptor including a first description indicating that allocation is released.

6. The storage device of claim 1, wherein, the storage controller is configured to, in response to the storage controller completing the operation according to the command for the nonvolatile memory, determine whether the pending queue is empty, and, in response to another command is stored in the pending queue, determine whether a channel having a workload not greater than the threshold workload from among the plurality of channels is present.

7. The storage device of claim 6, wherein, in response to at least one channel having a workload not greater than the threshold workload from among the plurality of channels is present, the storage controller is configured to select one channel having a lowest workload among the at least one channel from among the at least one channel, and queue the another command from the pending queue to allocate the another command to the one channel.

8. The storage device of claim 1, wherein, in response to a workload of the mapping channel exceeds the threshold workload, the storage controller is configured to queue the command without allocating the descriptor to the command.

9. The storage device of claim 1, wherein, in response to the pending queue being full, the storage controller is configured to push the command into the pending queue and queue an oldest command from the pending queue.

10. An operating method performed by a storage device, the method comprising:
receiving a command from a host device;
checking a workload of a mapping channel, to which the command is to be allocated, from among a plurality of channels;
in response to the workload of the mapping channel exceeding a threshold workload, queuing the command in a pending queue without allocating the command to the mapping channel; and
increasing the workload of the mapping channel in response to the workload of the mapping channel not being greater than the threshold workload, and allocating a descriptor for performing an operation according to the command to the command.

11. The method of claim 10, wherein
the workload is defined as a number of commands pre-allocated to the mapping channel, and
the queuing of the command includes queuing the command in response to the number of the pre-allocated commands exceeding a threshold number.

12. The method of claim 10, further comprising:
in response to the workload of the mapping channel exceeding the threshold workload, determining whether the pending queue is full.

13. The method of claim 12, further comprising:
in response to the pending queue being full, pushing the command into the pending queue and queuing an oldest command from the pending queue; and
in response to the pending queue not being full, queuing the command in the pending queue.

14. The method of claim 10, further comprising:
in response to completing the operation according to the command, determining whether the pending queue is empty; and
in response to another command being stored in the pending queue, determining whether a channel having a workload not greater than the threshold workload from among the plurality of channels is present.

15. The method of claim 14, wherein, in response to at least one channel having a workload not greater than the threshold workload from among the plurality of channels is present, selecting one channel having a lowest workload from among the at least one channel; and
queuing the another command from the pending queue to allocate the another command to the one channel.

16. The method of claim 10, wherein the command is allocated based on maintaining a condition that a workload for each of the plurality of channels is not less than the threshold workload, and
wherein the descriptor includes at least one sub-descriptor, the at least one sub-descriptor including a first description indicating that allocation is released.

17. The method of claim 10, wherein the queuing of the command includes:
queuing the command without allocating the descriptor to the command.

18. A storage controller connected to a nonvolatile memory through a plurality of channels and configured to control the nonvolatile memory, the storage controller comprising:
processing circuitry configured to
check a mapping channel, to which a command received from a host device is to be allocated, from among the plurality of channels,
check a workload of the mapping channel,
queue the command in a pending queue without allocating the command to the mapping channel in response to the workload of the mapping channel exceeding a threshold workload,
in response to the workload of the mapping channel not being greater than the threshold workload, increase the workload of the mapping channel, and
allocate a descriptor for performing an operation according to the command to the command.

19. The storage controller of claim 18, wherein, the workload is defined as a number of commands pre-allocated to the mapping channel, the processing circuitry is configured to queue the command in response to the number of the pre-allocated commands exceeding a threshold number.

20. The storage controller of claim 18, further comprising:
a buffer configured to store the pending queue.
